(19) United States
(12) Patent Application Publication
(10) Pub. No.: US 2009/0230866 A1
(43) Pub. Date: Sep. 17, 2009

(54) NEW MULTI-TUBE TYPE POWER-SAVING LAMP TUBE

(76) Inventor: Runlin He, Fujian (CN)

Correspondence Address: Dr. BANGER SHIA, 102 Lindencrest Ct., Sugar Land, TX, 77479-5201, US

(21) Appl. No.: 12/301,276

(22) PCT Filed: Dec. 21, 2007
(86) PCT No.: PCT/CN2007/071306

§ 371 Date: Nov. 18, 2008

(30) Foreign Application Priority Data
Dec. 22, 2006 (CN) 200620156593.1

(51) Int. Cl. H01J 61/30

(52) U.S. Cl. 313/634

(57) ABSTRACT

The present invention relates to multi-tube compact fluorescent lamp which includes at least two unitary light tubes connected together. Each unitary light tube is made of a single glass tube and has an enlarged portion. The enlarged portion of each unitary light tube has a plane side to be near to an adjacent unitary light tube. This structure is easy to manufacture and adapted for industrial production, has a compact configuration, provides greater power and better decoration, and is adapted for traditional light head and light shell.

### BACKGROUND OF THE INVENTION

1. Field of the Invention

The present invention relates to a compact fluorescent lamp, and more particularly to a multi-tube compact fluorescent lamp.

2. Description of the Prior Art

A conventional multi-tube compact florescent lamp comprises at least two unitary light tubes which are connected together. Each unitary light tube is formed by bending a single glass tube directly. The diameter of the tube is approximately even. This compact fluorescent lamp has some shortcomings: less power, bad lighting effect, larger size, not compact. The way to increase the power of the lamp is to lengthen the length of the glass tube or to widen the diameter of the glass tube. Thus, the lamp is larger in size and the structure is not compact. The way to limit the size of the lamp is to shorten the length of the glass tube or to decrease the diameter of the glass tube. Thus, the power of the lamp is less and the lighting surface is decreased, providing a bad lighting effect. In addition, the even glass tube makes the compact fluorescent lamp simple without decoration.

Chinese Patent Nos. 02272702.7 (as shown in FIG. 1 and FIG. 2) and 02272701.9 (as shown in FIGS. 3 through 5) disclose a bulb-shaped compact fluorescent lamp. This bulb-shaped compact fluorescent lamp comprises a lamp head 20 and a lamp body. The lamp head 20 and the lamp body are connected together. The shape of the lamp body is designed in a hollow bulb shape. The lamp body comprises a number of petal-shaped glass shells 30 which are connected together. Each glass shell 30 has a hollow body formed with two layers of arc glass. The cross-section of the glass shell 30 is a scraggy and irregular ring. The inner wall of the glass shell 30 is coated with fluorescent powder to light. Compare this bulb-shaped compact fluorescent lamp with the foresaid compact fluorescent lamp in the same size, the extended length of the glass shell 30 is longer than the length of the aforesaid glass tube and its diameter is widened to provide a greater power and a compact configuration. Furthermore, the lighting surface is increased so that the luminous flux is greater and the lighting effect is better. In addition, the lamp may be designed in a round bulb shape, a pointed bulb shape, a mushroom shape and so on for better decoration. But, this bulb-shaped compact fluorescent lamp still has the following shortcomings.

First of all, the glass shell 30 is a hollow body formed with two layers of arc glass. The hollow body is bent to form a petal shape. As shown in FIGS. 2, 3 and 5, when the glass shell 30 is shaped after bending, it will be difficult to cut the end where the glass shell 30 and the lamp head 20 are jointed because the cutting is finished on the scraggy and irregular curved surface and the rim of the end has edges and corners. It is hardly to cut an even surface at the end of the hollow body, accordingly, it is unable to manufacture a finished product. Therefore, the above-mentioned patents are to engage in idle theorizing. There are no real products on the market.

Secondly, to assume that the end the glass shell 30 is able to be cut, but there are edges and corners at the end where the glass shell 30 and the lamp head 20 are jointed and the end is an irregular ring. Under existing technology, the lampwick installed in the light tube is a regular circle. This regular circular lampwick is only mounted on a circular glass tube. Therefore, there is no corresponding lampwick existing on the market to couple with the glass shell 30 of the aforesaid patents, and it is very difficult to manufacture such an irregular lampwick. To seal the glass shell 30 and the irregular lampwick is also very difficult.

Furthermore, because the end where the glass shell 30 and the lamp head 20 are jointed is an irregular ring, when a number of glass shells 30 and a number of ends are jointed to the lamp head 20, it will be hard to arrange a number of ends on the same circle. Therefore, connecting the glass shells 30 to form a lamp is difficult, and the lamp body is neither compact nor beautiful.

In sum, even though the aforesaid patents have been granted, it is unable to solve the problems of production and assembly.

In addition, there is a single-tube compact fluorescent lamp, which is made of a single glass tube having a bulged section. The bulged section of the glass tube is to widen the diameter of the tube. This increases the lighting surface and the power so that the luminous flux is larger and the lighting effect is better. But, if the single-tube compact fluorescent lamp is assembled to form a multi-tube compact fluorescent lamp, because the whole wall of the glass tube is bulged outward, it is unable to made two adjacent glass tubes approach with each other. The multi-tube compact fluorescent lamp is lager in size and not compact. The ends of the glass tubes are scattered, which is hard to couple with a common lamp head and is unable to form a multi-tube compact fluorescent lamp in a round bulb shape, a pointed bulb shape, a mushroom shape and so on. Therefore, the existing single-tube compact fluorescent lamp is unable to assemble a multi-tube compact fluorescent lamp. Accordingly, the inventor of the present invention has devoted himself based on his many years of practical experiences to the development of a multi-tube compact fluorescent lamp.

### SUMMARY OF THE INVENTION

The primary object of the present invention is to provide a multi-tube compact fluorescent lamp, which is easy to manufacture, has a compact configuration, provides greater power and better decoration, and applies to a traditional light head and a light shell.

In order to achieve the aforesaid object, there is provided a multi-tube compact fluorescent lamp, comprising at least two unitary light tubes connected together, each said unitary light tube being made of a single glass tube and having an enlarged portion, said enlarged portion of each said unitary light tube having a plane side to be near to an adjacent enlarged portion.

Each said unitary light tube made of a single glass tube is bent first and then blown out during manufacture, a side section of each said unitary light tube having said enlarged portion, said enlarged portions of adjacent unitary light tubes approaching each other. Said side section of each said unitary light tube is gradually enlarged from a bent end towards a light head end, said two unitary light tubes being connected together at the light head end to form the compact fluorescent lamp in a rocket or candle shape. Said side section of each said unitary light tube is gradually enlarged from a light head end towards a bent end, said two unitary light tubes being connected together at the light head end to form the compact fluorescent lamp in a mushroom shape. Said side section of each said unitary light tube is gradually enlarged from a bent end towards a light head end and then gradually tapered, at least three unitary light tubes being connected together at the light head end to form the compact fluorescent lamp in a sphere shape.

Each said unitary light tube made of a single glass tube is bent first and then blown out during manufacture, each said unitary light tube having a bent end as said enlarged portion, said two unitary light tubes being connected together at a light head end, said enlarged portions of adjacent unitary light tubes approaching each other to form the compact fluorescent lamp in a heart or sphere shape.

Each said unitary light tube made of a single glass tube is bent first and then blown out during manufacture, a straight section of each said unitary light tube having an enlarged portion, said enlarged portions of adjacent unitary light tubes approaching each other. Said straight section of each said unitary light tube is gradually enlarged from an end far away from a light head towards a light head end, said two unitary light tubes being connected together at the end far away from the light head to form the compact fluorescent lamp in a rocket or candle shape. Said straight section of each said unitary light tube is gradually enlarged from a light head end towards an end far away from a light head, said two unitary light tubes being connected together at the end far away from the light head to form the compact fluorescent lamp in a mushroom shape. Said straight portion of each said unitary light tube is gradually enlarged from an end far away from a light head towards a light head end and then gradually tapered, at least three unitary light tubes being connected together at the end far away from the light head to form the compact fluorescent lamp in a sphere shape.

The present invention provides the unitary light tube made of a single glass tube. Each unitary light tube has en enlarged portion. The diameter of the enlarged portion is widened by means of a different mold and the related technic to make the lamp in a decorative shape. The present invention has the following advantages.

1. Each unitary light tube is formed with an enlarged portion to widen the diameter of the tube and to increase the power. Compared to a conventional compact fluorescent lamp with the same power, it is not necessary to lengthen the length of the unitary light tube of the present invention. The entire lamp is compact in size.

2. After the diameter of each unitary light tube is widened, the power is increased. Compared to a conventional compact fluorescent lamp in the same size, the present invention is able to shorten the length of each unitary light tube and to ensure that the power of the compact fluorescent lamp is enough. Furthermore, widening the diameter of the tube is to increase the lighting surface and the luminous flux, providing a better lighting effect.

3. The enlarged portion may be designed according to a specific position or various shapes. After the unitary light tubes are assembled, the compact fluorescent lamp of the present invention may be in various shapes for better decoration.

The aforesaid three advantages are similar to Chinese Patent Nos. 02272702.7 and 02272701.9, but they are better than a conventional multi-tube compact fluorescent lamp (the unitary light tube is formed by bending a single glass tube). Besides, compared to Chinese Patent Nos. 02272702.7 and 02272701.9, the present invention further has the following advantages.

4. The unitary light tube is still made of a single glass tube. When the unitary light tube is shaped, the junction of the unitary light tube and the light head is still a circular glass tube. The cutting of the jointed ends is finished on the wall of the smooth glass tube, which belongs to a traditional cutting technic of glass tube, not like the teaching of Chinese Patent Nos. 02272702.7 and 02272701.9. Therefore, the present invention is easy to cut the jointed ends.

5. After the unitary light tube is cut, the end surface is a regular and circular surface which is adapted for the seal of the existing lampwick in a regular and circular shape. This belongs to a traditional technic to seal the light tube. Chinese Patent Nos. 02272702.7 and 02272701.9 need special lampwicks. To couple the unitary light tube of the present invention with the lampwick is easy.

6. The end surface of the junction of the unitary light tube and the light head is a regular and circular surface. When a number of unitary light tubes are connected to form a compact fluorescent lamp which is then connected to a light head, the multiple circular end surfaces are easy to arrange on the same circle, not like the teaching of Chinese Patent Nos. 02272702.7 and 02272701.9. This also belongs to a traditional assembly technic. The unitary light tubes of the present invention are connected to form a compact fluorescent lamp which is compact and beautiful.

7. Only a partial section of the unitary light tube is enlarged, there is no change for the junction of the unitary light tube and the light head. Therefore, a traditional light head is still adapted for the unitary light tube of the present invention. The compact fluorescent lamp of the present invention is still adapted for a traditional light shell, which is convenient for use and assembly.

In addition, compared to the existing multi-tube compact fluorescent lamp, the present invention has the following advantage.

8. The enlarged portion of each unitary light tube has a plane side to be near to an adjacent enlarged portion. This design of the plane side is favorable for approaching an adjacent unitary light tube so that the multi-tube compact fluorescent lamp is smaller in size and more compact. This is advantageous for changes in shape and arrangement of the ends of the unitary light tubes to connect with a traditional light head.

In sum, the present invention has a compact configuration, greater power and better decoration, is easy to manufacture, seal and assemble, and is adapted for a traditional light head and a light shell. These advantages are not disclosed in Chinese Patent Nos. 02272702.7 and 02272701.9. Compared to the existing single-tube bulged compact fluorescent lamp, the unitary light tubes of the present invention are assembled to form a multi-tube compact fluorescent lamp directly. The present invention is easy to manufacture, seal, and assemble, which is adapted for industrial production and popularization.

### BRIEF DESCRIPTION OF THE DRAWINGS

FIG. 1 is a side view of Chinese Patent No. 02272702.7;

FIG. 2 is a cross-sectional view of Chinese Patent No. 02272702.7;

FIG. 3 is a side view of Chinese Patent No. 02272701.9;

FIG. 4 is a side view of a light body of Chinese Patent No. 02272701.9;

FIG. 5 is a top view of Chinese Patent No. 02272701.9;

FIG. 6 is a perspective view of a first preferred embodiment of the present invention;

FIG. 6A is a side view of the first preferred embodiment of the present invention;

FIG. 6B is a bottom view of the first preferred embodiment of the present invention;

FIG. 6C is a top view of the first preferred embodiment of the present invention;

FIG. 7 is a perspective view of a second preferred embodiment of the present invention;

FIG. 7A is a side view of the second preferred embodiment of the present invention;

FIG. 7B is a bottom view of the second preferred embodiment of the present invention;

FIG. 7C is a top view of the second preferred embodiment of the present invention;

FIG. 8 is a perspective view of a third preferred embodiment of the present invention;

FIG. 8A is a side view of the third preferred embodiment of the present invention;

FIG. 8B is a bottom view of the third preferred embodiment of the present invention; and

FIG. 8C is a top view of the third preferred embodiment of the present invention.

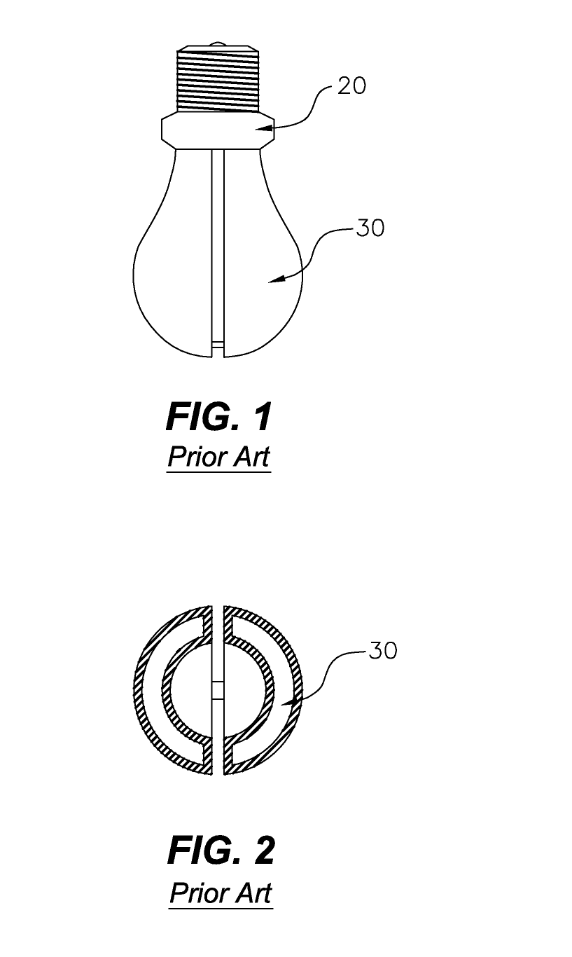

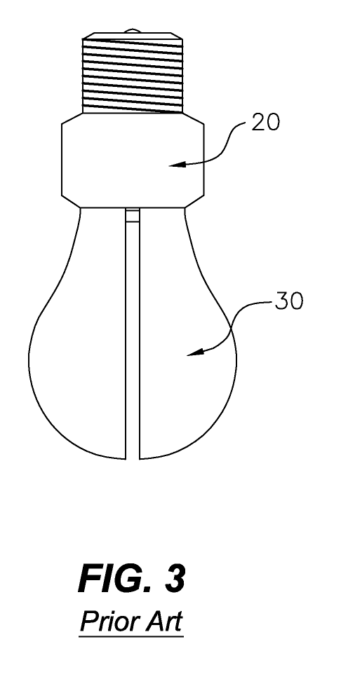

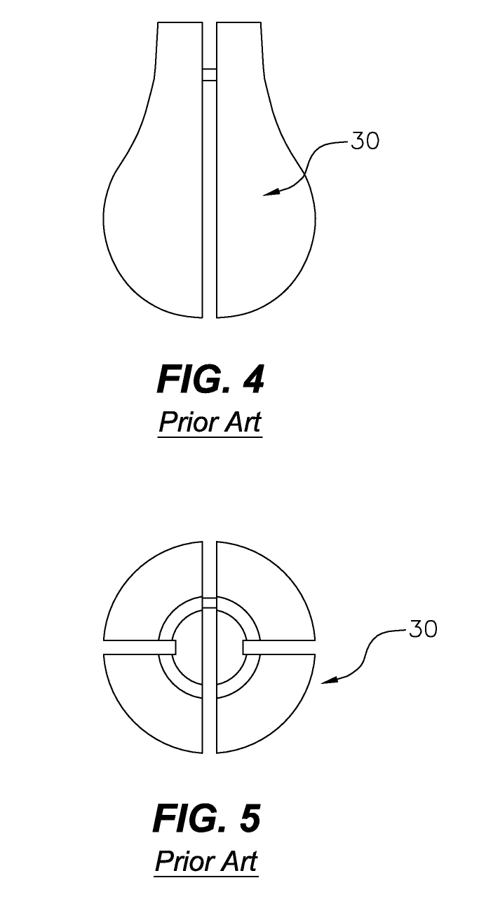

### DETAILED DESCRIPTION OF THE PREFERRED EMBODIMENTS

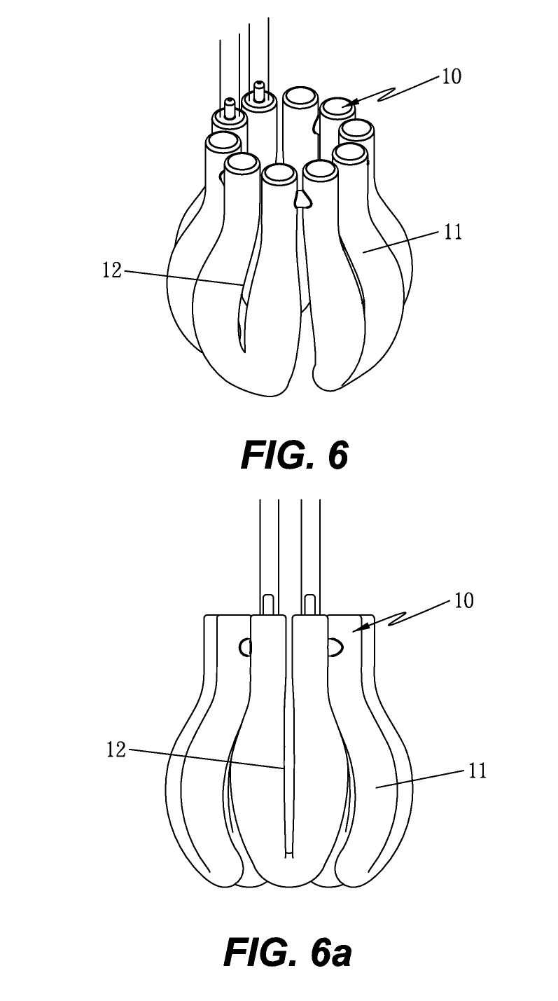

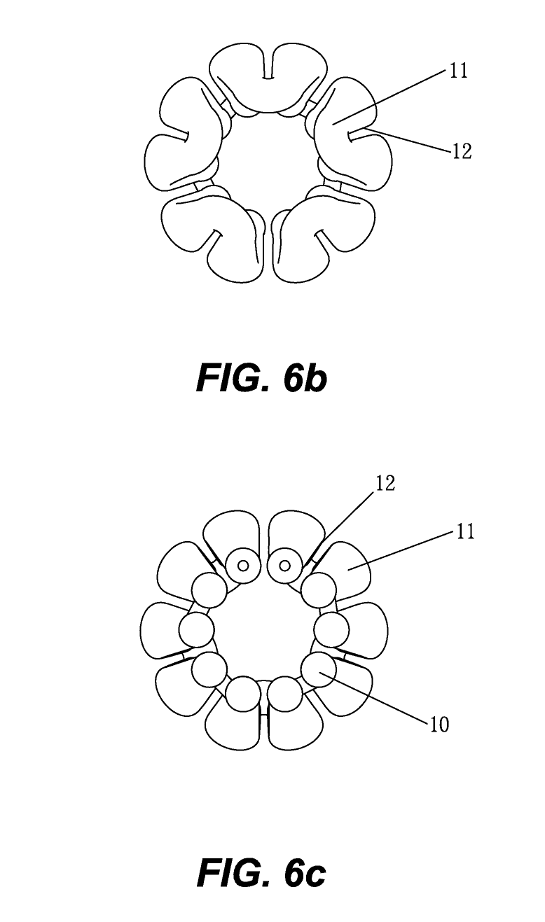

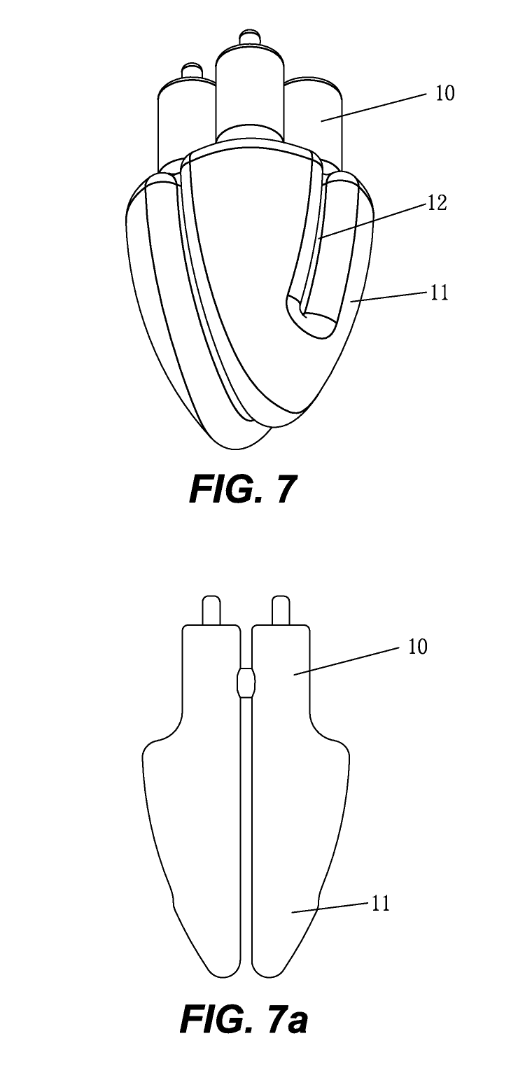

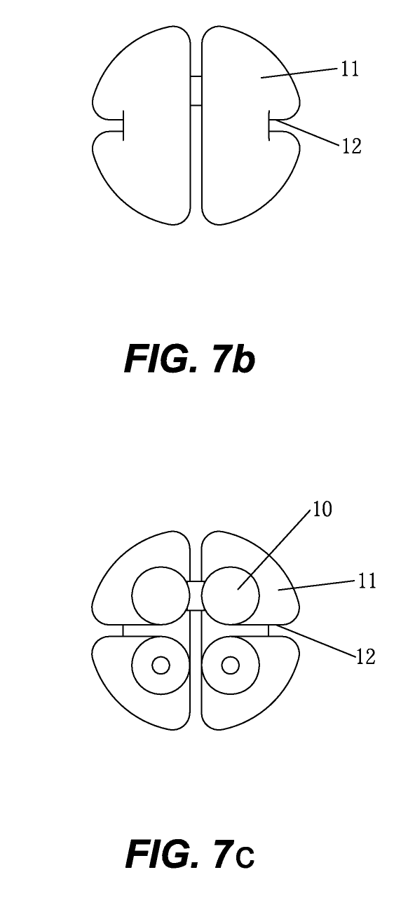

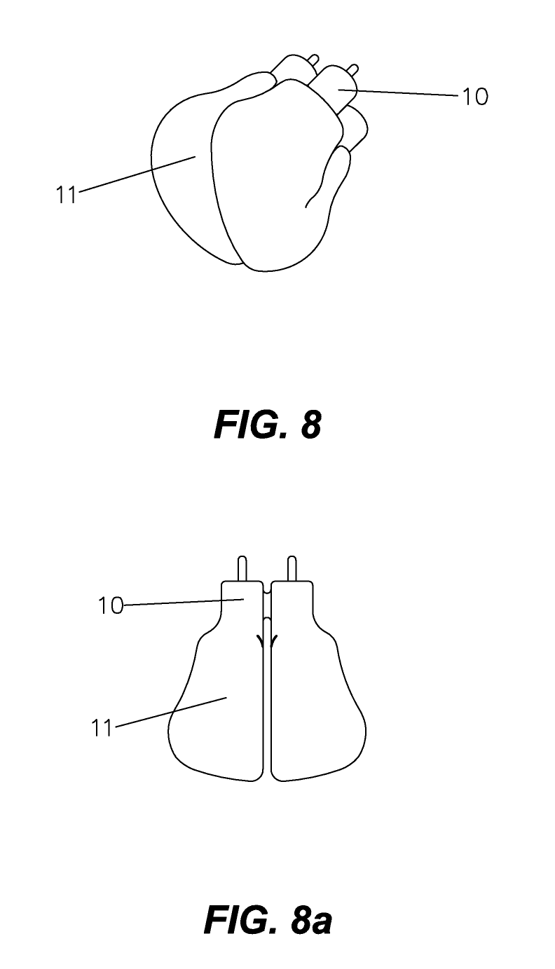

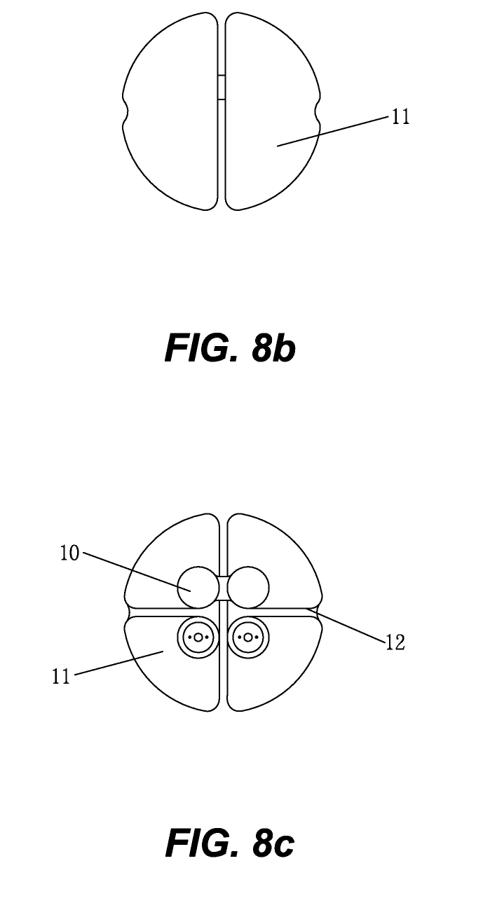

As shown in FIG. 6, FIG. 7 and FIG. 8, a multi-tube compact fluorescent lamp of the present invention comprises at least two unitary light tubes 10 which are connected together. Each unitary light tube 10 is made of a single glass tube and has an enlarged portion 11. The enlarged portion 11 of each unitary light tube 10 has a plane side 12 to be near to an adjacent enlarged portion 11. The number of the unitary light tube 10 and the position of the enlarged portion 11 depend on the design of the compact fluorescent lamp. The enlarged portion 11 is only enlarged at a partial section of the unitary light tube 10 by means of a different mold and the related technic. FIG. 6, FIG. 7 and FIG. 8 show three preferred embodiments of the present invention.

As shown in FIG. 6 through FIG. 6C, a first preferred embodiment of the compact fluorescent lamp comprises a number of (about 4-5) unitary light tubes 10 which are connected together. The connected position is near a connecting end of a light head. The unitary light tube 10 is made of a single glass tube which is bent first and then blown out during manufacture. The side section of each unitary light tube 10 has an enlarged portion 11 which is gradually enlarged from a bent end towards a light head end and then tapered gradually. The enlarged portion 11 at the side section of each unitary light tube 10 has a plane side 12 to be near to the enlarged portion 11 of an adjacent unitary light tube 10. When the unitary light tubes 10 are connected together, the place sides 12 of the enlarged portions 11 approach each other so that the lamp is in a sphere shape. The shape of this compact fluorescent lamp is nearly an ordinary sphere lamp having a shell. The present invention saves the cost of the shell, decreases the light to be shaded, has a better lighting effect, and has a shape similar to a traditional incandescent lamp.

As shown in FIG. 7 through FIG. 7C, a second preferred embodiment of the compact fluorescent lamp comprises two unitary light tubes 10 which are connected together. The unitary light tube 10 is made of a single glass tube which is bent first and then blown out during manufacture. The side section of each unitary light tube 10 has an enlarged portion 11 which is gradually enlarged from a bent end towards a light head end. The enlarged portion 11 at the side section of each unitary light tube 10 has a plane side 12 to be near to the enlarged portion 11 of an adjacent unitary light tube 10. When the two unitary light tubes 10 are connected together, their enlarged portions 11 approach each other with their plane sides 12 so that the lamp is in a rocket or candle shape.

As shown in FIG. 8 through FIG. 8C, a third preferred embodiment of the compact fluorescent lamp comprises two unitary light tubes 10 which are connected together. The unitary light tube 10 is made of a single glass tube which is bent first and then blown out during manufacture. The side section of each unitary light tube 10 has an enlarged portion 11 which is gradually enlarged from a light head end towards a bent end. The enlarged portion 11 of each unitary light tube 10 has a plane side 12 to be near to the enlarged portion 11 of an adjacent unitary light tube 10. When the two unitary light tubes 10 are connected together, their enlarged portions 11 approach each other with their plane sides 12 so that the lamp is in a mushroom shape.

Each of the unitary light tubes 10 may be in other specific shape. The unitary light tube 10 is made of a single glass tube which is bent first and then blown out during manufacture. The bent end of each unitary light tube 10 is the enlarged portion 11. The enlarged portion 11 of each unitary light tube 10 has a plane side 12 to be near to the enlarged section 11 of an adjacent unitary light tube 10. The connected position is near a connecting end of a light head. When the unitary light tubes 10 are connected together, their enlarged portions 11 approach each other with their plane sides 12 so that the lamp is in a heart or sphere shape.

Each of the unitary light tubes of the present invention may be made of a single glass tube which is blown out directly during manufacture, and the connected position is at the end far away from the light head so that the unitary light tubes are connected to form a compact fluorescent lamp. The enlarged portion is directly formed on a straight section of the unitary light tube. The adjacent unitary light tubes approach each other with the plane sides of their enlarged portions. The unitary light tubes of this structure may be gradually enlarged from the end far away from the light head towards the light head to form a rocket or candle shape, as shown in FIG. 7. The unitary light tubes of this structure may be gradually enlarged from the light head end towards the end far away from the light head to form a mushroom shape, as shown in FIG. 8. The unitary light tubes of this structure may be gradually enlarged from the bent end towards the light head end and then tapered gradually to form a sphere shape, as shown in FIG. 6. Various shapes are not described herein.

The feature of the present invention is that the unitary light tube is made of a single glass tube. A partial section of the unitary light tube is enlarged according to the design. The enlarged portion of each unitary light tube has a plane side to be near to the enlarged portion of an adjacent unitary light tube. Thus, the processing technics of the present invention to cut the connecting end of the unitary light tube and the light head, to seal the lampwick, to connect the unitary light tubes, and to connect the compact fluorescent lamp with the light head are similar to the traditional technics. Compared to Chinese Patent Nos. 02272702.7 and 02272701.9, the present invention is able to be accomplished. Furthermore, the design of the plane side of the enlarged portion makes the unitary light tubes close together. The present invention is easy to manufacture, adapted for industrial production and popularization, and able to couple with a traditional light head and a traditional light shell, which is convenient in use.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A multi-tube compact fluorescent lamp, comprising at least two unitary light tubes connected together, each said unitary light tube being made of a single glass tube and having an enlarged portion, said enlarged portion of each said unitary light tube having a plane side to be near to an adjacent enlarged portion.

2. The multi-tube compact fluorescent lamp as claimed in claim 1, wherein each said unitary light tube made of a single glass tube is bent first and then blown out during manufacture, a side section of each said unitary light tube having said enlarged portion, said enlarged portions of adjacent unitary light tubes approaching each other.

3. The multi-tube compact fluorescent lamp as claimed in claim 2, wherein said side section of each said unitary light tube is gradually enlarged from a bent end towards a light head end, said two unitary light tubes being connected together at the light head end to form the compact fluorescent lamp in a rocket or candle shape.

4. The multi-tube compact fluorescent lamp as claimed in claim 2, wherein said side section of each said unitary light tube is gradually enlarged from a light head end towards a bent end, said two unitary light tubes being connected together at the light head end to form the compact fluorescent lamp in a mushroom shape.

5. The multi-tube compact fluorescent lamp as claimed in claim 2, wherein said side section of each said unitary light tube is gradually enlarged from a bent end towards a light head end and then gradually tapered, at least three unitary light tubes being connected together at the light head end to form the compact fluorescent lamp in a sphere shape.

6. The multi-tube compact fluorescent lamp as claimed in claim 1, wherein each said unitary light tube made of a single glass tube is bent first and then blown out during manufacture, each said unitary light tube having a bent end as said enlarged portion, said two unitary light tubes being connected together at a light head end, said enlarged portions of adjacent unitary light tubes approaching each other to form the compact fluorescent lamp in a heart or sphere shape.

7. The multi-tube compact fluorescent lamp as claimed in claim 1, wherein each said unitary light tube made of a single glass tube is bent first and then blown out during manufacture, a straight section of each said unitary light tube having an enlarged portion, said enlarged portions of adjacent unitary light tubes approaching each other.

8. The multi-tube compact fluorescent lamp as claimed in claim 7, wherein said straight section of each said unitary light tube is gradually enlarged from an end far away from a light head towards a light head end, said two unitary light tubes being connected together at the end far away from the light head to form the compact fluorescent lamp in a rocket or candle shape.

9. The multi-tube compact fluorescent lamp as claimed in claim 7, wherein said straight section of each said unitary light tube is gradually enlarged from a light head end towards an end far away from a light head, said two unitary light tubes being connected together at the end far away from the light head to form the compact fluorescent lamp in a mushroom shape.

10. The multi-tube compact fluorescent lamp as claimed in claim 7, wherein said straight portion of each said unitary light tube is gradually enlarged from an end far away from a light head towards a light head end and then gradually tapered, at least three unitary light tubes being connected together at the end far away from the light head to form the compact fluorescent lamp in a sphere shape.
